(19) United States
(12) Patent Application Publication
(10) Pub. No.: US 2025/0060526 A1
(43) Pub. Date: Feb. 20, 2025

(54) SIGNAL MANIPULATION ELEMENTS INTEGRATED WITH WINDOW PLATE FOR OPTICAL FEEDTHROUGH TO VACUUM

(71) Applicant: Quantinuum LLC, Broomfield, CO (US)

(72) Inventors: Adam Jay OLLANIK, Boulder, CO (US); David M GAUDIOSI, Loveland, CO (US); Duc Anh NGUYEN, Westminster, CO (US); Rezlind BUSHATI, Rockville, MD (US); Steve SANDERS, Broomfield, CO (US); Mary ROWE, Boulder, CO (US); Sara CAMPBELL, Louisville, CO (US); Justin SCHULTZ, Westminster, CO (US); Bryan DEBONO, Denver, CO (US); Matt BOHN, Broomfield, CO (US)

(21) Appl. No.: 18/757,109

(22) Filed: Jun. 27, 2024

Related U.S. Application Data
(60) Provisional application No. 63/519,328, filed on Aug. 14, 2023.
(60) Provisional application No. 63/602,979, filed on Nov. 27, 2023.

(51) Int. Cl. F21V 8/00; G21K 1/00; G21K 1/06

(52) U.S. Cl. CPC G02B 6/0095; G21K 1/003; G21K 1/06; G21K 2201/067

(57) ABSTRACT

A controlled environment chamber is provided. The controlled environment chamber includes a chamber housing and a window component that is secured to the chamber housing. The window component includes a window plate having a first surface that faces away from an interior of the controlled environment chamber and a second surface that faces toward the interior of the controlled environment chamber. The window plate comprises at least one signal manipulation element.

### CROSS-REFERENCE TO RELATED APPLICATION

This application claims priority to Provisional Patent Application No. 63/519,328, filed Aug. 14, 2023, and Provisional Patent Application No. 63/602,979, filed Nov. 27, 2023, the contents of each of which are hereby incorporated by reference in their entireties.

### TECHNICAL FIELD

Various embodiments relate to a controlled environment chamber and/or a window component of a controlled environment chamber. For example, various embodiments relate to an optical feedthrough formed in a window component of a controlled environment chamber.

### BACKGROUND

In various scenarios, it is desirable to pass optical signals from outside a controlled environment chamber to the inside of a controlled environment chamber, or vice versa. For example, the optical signals may include laser beams used to perform experiments on quantum objects (e.g., ions, atoms, quantum dots, and/or the like) confined within the controlled environment chamber. In another example, the optical signals may include fluorescence signals generated by quantum objects confined within the controlled environment chamber. However, forming an opening in the housing of the controlled environment chamber to act as an optical fiber feedthrough decreases the efficiency with which the controlled environment within the controlled environment chamber may be controlled. Through applied effort, ingenuity, and innovation many deficiencies of such systems have been solved by developing solutions that are structured in accordance with the embodiments of the present invention, many examples of which are described in detail herein.

### BRIEF SUMMARY

Example embodiments provide controlled environment chambers, window components for controlled environment chambers, methods of manufacturing window components and controlled environment chambers comprising such window components. For example, a window component may include a window plate having a first surface and a second surface. At least one signal manipulation element is integrated with the first surface, the second surface, and/or the core of the window plate.

In various aspects, a controlled environment chamber is provided. The controlled environment chamber may include a chamber housing and a window component secured to the chamber housing. The window component may include a window plate having a first surface that faces away from an interior of the controlled environment chamber and a second surface that faces toward the interior of the controlled environment chamber. The window plate may include at least one signal manipulation element.

In various examples, the window plate has a core that is defined between the first surface and the second surface. The at least one signal manipulation element may be embedded within the core of the window plate.

In various examples, an inside of the controlled environment chamber is configured for providing an ultra-high vacuum that is less than 10-7 mbar.

In various examples, a first signal manipulation element of the at least one signal manipulation element is positioned on the first surface of the window plate. A second signal manipulation element of the at least one signal manipulation element can be positioned on the second surface of the window plate.

In various examples, each of the at least one signal manipulation element is configured to control at least one light characteristic of a beam of light passing through the respective signal manipulation element.

In various examples, the at least one light characteristic is an amplitude, a phase, a polarization, a modality, a propagation direction, a spectrum of light, or a combination thereof.

In various examples, each of the at least one signal manipulation element is configured to split a beam of light passing through the respective signal manipulation element.

In various examples, the controlled environment chamber includes a photonic interconnect system. The photonic interconnect system may include at least one external beam path system, the window plate that includes the at least one signal manipulation element, and at least one internal beam path system. Each of the at least one signal manipulation element of the window plate may be positioned between a corresponding external beam path system and a corresponding internal beam path system.

In various examples, the at least one internal beam path system is optically coupled to a confinement apparatus.

In various examples, the confinement apparatus is an ion trap that is configured to confine at least one quantum object.

In various examples, the at least one external beam path system or the at least one internal beam path system is configured to transmit a beam of light through a respective signal manipulation element and the other of the at least one external beam path system or the at least one internal beam path system is configured to receive the beam of light that is transmitted through the respective signal manipulation element.

In various examples, the photonic interconnect system includes an array of external beam path systems that collectively define a first shape, and an array of internal beam path systems that collectively define a second shape, the second shape being different than the first shape.

In various examples, the at least one signal manipulation element is configured to receive a plurality of beams of light from the array of external beam path systems, modify the propagation direction of at least one of the plurality of beams of lights such that the plurality of beams of light that are emitted by the signal manipulation element define the second shape.

In various examples, the at least one external beam path system and/or the at least one internal beam path system is coupled to the chamber housing or the window component with a reversible mounting technique.

In various aspects, a method of fabricating a controlled environment chamber is provided. The method may include integrating at least one signal manipulation element with a window plate, coupling at least one internal beam path system to a chamber housing of the controlled environment chamber or to a window component that includes the window plate, securing the window component to the chamber housing, and coupling at least one external beam path system to the chamber housing or to the window component.

In various examples, the method includes aligning the at least one external beam path system with the at least one signal manipulation element and the at least one internal beam path system.

In various examples, the method includes using an alignment tool to (1) assist with positioning the at least one internal beam path system or the at least one external beam path system and/or (2) assist with monitoring the position of the at least one internal beam path system or the at least one external beam path system.

In various examples, coupling the at least one external beam path system to the chamber housing or to the window component includes coupling the at least one external beam path system to the chamber housing or to the window component with a reversible mounting technique.

In various examples, the method includes securing the window plate within a collar, the collar being configured to couple the window component to the chamber housing of the controlled environment chamber.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 provides block diagram of an example system comprising a controlled environment chamber, in accordance with an example embodiment.

FIG. 2 provides a perspective view of a window component, in accordance with an example embodiment.

FIG. 3 provides a schematic diagram of a portion of the example system of FIG. 1, in accordance with an example embodiment.

FIG. 4 provides a schematic diagram of a portion of the example system of FIG. 1, in accordance with an example embodiment.

FIG. 5 provides a flowchart illustrating various processes and/or procedures for fabricating a window component and/or a controlled environment chamber including a window component, in accordance with an example embodiment.

FIG. 6 provides a schematic diagram of an example controller of a quantum computer comprising a confinement apparatus disposed within a controlled environment chamber, in accordance with an example embodiment.

FIG. 7 provides a schematic diagram of an example classical computing entity of a quantum computer system that may be used in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the term “electrical communication” or “electrically coupled” means that an electric current and/or an electric signal are capable of making the connection between the areas specified. As used herein, the term “optical communication” or “optically coupled” means that light and/or an optical signal are capable of making the connection between the areas specified.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the term “positioned directly on” refers to a first component being positioned on a second component such that they make contact. Similarly, as used herein, the term “positioned directly between” refers to a first component being positioned between a second component and a third component such that the first component makes contact with both the second component and the third component. In contrast, a first component that is “positioned between” a second component and a third component may or may not have contact with the second component and the third component. Additionally, a first component that is “positioned between” a second component and a third component is positioned such that there may be other intervening components between the second component and the third component other than the first component.

In various scenarios, a controlled environment chamber is used to provide a controlled environment. For example, the controlled environment chamber may be a cryogenic and/or vacuum chamber configured for providing a temperature controlled and/or pressure-controlled environment within the controlled environment chamber. For example, experiments may be performed within a controlled environment (e.g., a temperature controlled, humidity controlled, pressure controlled, and/or the like) inside the controlled environment chamber. In various instances, it is desirable to pass optical signals from outside the controlled environment chamber to the inside of a controlled environment chamber, or vice versa. For example, the optical signals may include laser beams used to perform experiments on quantum objects (e.g., ions, atoms, quantum dots, and/or the like) confined within the controlled environment chamber. In another example, the optical signals may include fluorescence signals generated by quantum objects confined within the controlled environment chamber.

However, forming an opening in the housing of the controlled environment chamber to act as an optical fiber feedthrough decreases the efficiency with which the controlled environment within the controlled environment chamber may be controlled. For example, an opening in a housing of a vacuum chamber may limit the pressure to which the environment within the vacuum chamber may be reduced. Moreover, an opening in the housing of the vacuum chamber or using a different material for a feedthrough can add thermal expansion complications or reduce the mechanical stability of the housing. Therefore, technical problems exist regarding how to pass optical signals through the chamber housing of a controlled environment chamber without negatively affecting the operability of the controlled environment chamber.

Various embodiments provide technical solutions to these technical problems. For example, various embodiments provide a window component for a controlled environment chamber that includes at least one signal manipulation element integrated with the window plate. In various examples, the at least one signal manipulation element is a metasurface that is integrated with at least one surface of a window plate.

In various examples, the at least one signal manipulation element is an optical element, such as a diffractive optical element (DOE), that is integrated with the core of the window plate (i.e., integrated with the interior of the window plate such that the signal manipulation element is not on the surface of the window plate). The at least one signal manipulation element can be integrated with the core of the window plate with a laser processing or an ion implantation technique to embed the at least one signal manipulation element by locally modifying the refractive index of the material of the window plate. In various examples, the at least one signal manipulation element is a photonic device that is embedded within the core of the window plate. The core of the window plate may be defined between a first surface and a second surface of the window plate.

Optical beams may therefore be passed through the window plate via the at least one signal manipulation element. The window component seals an opening in the housing chamber of the controlled environment chamber and provides means for passing optical signals therethrough. Moreover, the window component retains the mechanical stability of the housing. Thus, various embodiments provide improvements to controlled environment chambers and systems including controlled environment chambers.

### Example System Including a Controlled Environment Chamber

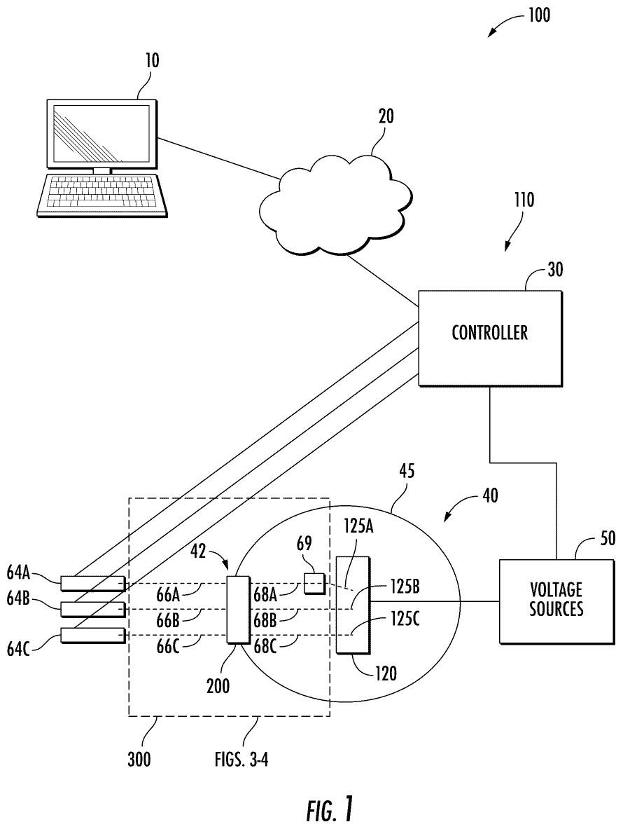

FIG. 1 provides a schematic diagram of an example system that includes a controlled environment chamber 40. The illustrated example system is a quantum computing system comprising a confinement apparatus 120 (e.g., an ion trap, an atomic trap) configured to confine quantum objects (e.g., neutral or ionic atoms; neutral, ionic, or multipolar molecules; quantum dots; and/or other quantum particles) disposed within a controlled environment chamber 40. The controlled environment chamber 40 comprises a chamber housing 45 having an opening 42 formed therein. The controlled environment chamber 40 further comprises a window component 200 configured to environmentally seal the opening 42. For example, the window component 200 may prevent air from the environment outside of the chamber housing 45 from entering the controlled environment chamber 40 via the opening 42.

In various embodiments, the controlled environment chamber 40 is configured to provide a controlled environment inside the chamber housing 45. For example, the temperature, pressure, humidity, atmospheric make up and/or contents, and/or the like may be controlled within the controlled environment chamber 40. In an example embodiment, the controlled environment chamber 40 is a cryogenic and/or pressure chamber.

In various embodiments, the controlled environment chamber 40 is a part of a system configured for performing experiments, controlled quantum state evolution, and/or the like on quantum objects confined by a confinement apparatus 120 within the controlled environment chamber 40. In the illustrated system of the quantum computer system, the system comprises a computing entity 10 and a quantum computer 110.

In various embodiments, the quantum computer 110 comprises a controller 30, a controlled environment chamber 40 enclosing a confinement apparatus 120, one or more manipulation sources 64 (e.g., 64A, 64B, 64C), one or more voltage sources 50, one or more magnetic field generators, an optics collection system, and/or the like. In various embodiments, the controller 30 is configured to control the operation of (e.g., control one or more drivers configured to cause operation of) the manipulation sources 64, voltage sources 50, magnetic field generators, a vacuum system and/or cryogenic cooling system (not shown), and/or the like. In various embodiments, the controller 30 is configured to receive signals (e.g., electrical signals) generated and provided by one or more photodetectors of the optics collection system.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more quantum objects confined by the confinement apparatus 120. For example, a respective manipulation source 64 is configured to generate and/or provide a respective manipulation signal (e.g., an optical signal) configured to be incident one or more quantum objects located at a respective target location 125 (e.g., 125A, 125B, 125C) defined at least in part by the confinement apparatus 120.

A respective manipulation source 64 emits a respective manipulation signal and the respective manipulation signal is guided to the controlled environment chamber 40 via a respective external beam path system 66 (e.g., 66A, 66B, 66C). In various embodiments, a respective external beam path system 66 comprises a respective optical fiber, such as a fiber array (e.g., v-groove fiber array), free space optics, such as a free-space beam array), a photonic integrated circuit (PIC), such as a PIC chip with an array of outputs (e.g., facet array or grating array), and/or the like. The respective manipulation signal is transmitted to at least one signal manipulation element 250 that is integrated with a window plate 220 of the window component 200. The respective manipulation signal is then transmitted to a respective internal beam path system 68 (e.g., 68A, 68B, 68C). In various embodiments, the respective internal beam path system 68 comprises a respective optical fiber, such as a fiber array (e.g., v-groove fiber array), free space optics, such as a free-space beam array), a photonic integrated circuit 69, such as a PIC chip with an array of inputs and/or outputs (e.g., facet array or grating array), and/or the like. In various embodiments, the respective internal beam path system 68 is configured to cause the respective manipulation signal to be incident on the respective target location 125 defined at least in part by the confinement apparatus 120. In various embodiments, the manipulation sources 64, active components of the external and internal beam path systems 66, 68 (e.g., modulators, etc.), and/or other components of the quantum computer 110 are controlled by the controller 30.

In various embodiments, the confinement apparatus 120 is an ion trap, such as a surface ion trap, Paul ion trap, and/or the like. In various embodiments, the confinement apparatus 120 is an optical trap, magnetic trap, and/or other confinement apparatus configured to confine quantum objects. In various embodiments, the quantum objects are neutral or ionic atoms; neutral, ionic, or multipolar molecules; quantum dots; and/or other quantum particles.

In various embodiments, the quantum computer 110 comprises one or more voltage sources 50. For example, the voltage sources may be arbitrary wave generators (AWG), digital analog converters (DACs), and/or other voltage signal generators. For example, the voltage sources 50 may comprise a plurality of control voltage drivers and/or voltage sources and/or at least one RF driver and/or voltage source. The voltage sources 50 may be electrically coupled to the corresponding potential generating elements (e.g., control electrodes and/or RF electrodes, and/or the like) of the confinement apparatus 120, in an example embodiment. In various embodiments, the controller 30 is configured to control operation of the one or more voltage sources 50.

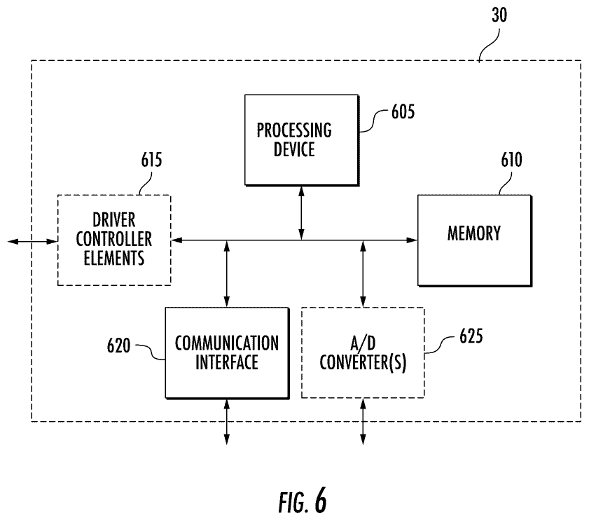

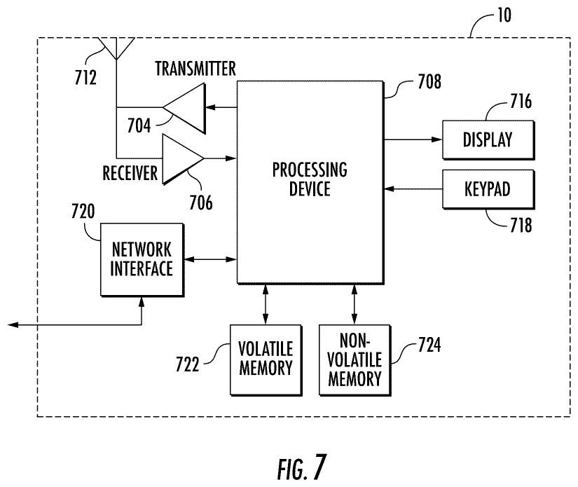

In various embodiments, the quantum computer 110 comprises an optics collection system configured to collect and/or detect photons (e.g., stimulated emission and/or fluorescence) generated by quantum objects confined by the confinement apparatus 120 (e.g., during qubit reading procedures). The optics collection system may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits (e.g., atomic objects) of the quantum computer 110. In various embodiments, the photodetectors may be in electronic communication with the quantum computer controller 30 via one or more A/D converters 625 (see FIG. 6) and/or the like. In an example embodiment, the photodetectors are disposed inside the controlled environment chamber 40. In an example embodiment, the photodetectors are disposed outside the controlled environment chamber 40 and photons collected by the optical collection system are provided to the photodetectors via an internal beam path system 68, at least one signal manipulation element 250 of the window component 200 and an external beam path system 66.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control operation of the voltage sources 50, magnetic field generators, cryogenic system and/or vacuum system controlling the temperature and pressure within the controlled environment chamber 40 (and/or other systems configured to control the environment within the controlled environment chamber 40), manipulation sources 64, so as to manipulate and/or cause a controlled evolution of quantum states of one or more quantum objects confined by the confinement apparatus 120, and/or read and/or detect a quantum (e.g., qubit) state of one or more quantum objects confined by the confinement apparatus 120. For example, the controller 30 may cause a controlled evolution of quantum states of one or more quantum objects within the confinement apparatus 120 to execute a quantum circuit and/or algorithm. For example, the controller 30 may read and/or detect quantum states of one or more quantum objects within the confinement apparatus 120 at one or more points during the execution of a quantum circuit. In various embodiments, the quantum objects confined by the confinement apparatus 120 are used as qubits of the quantum computer 110.

### Example Window Component

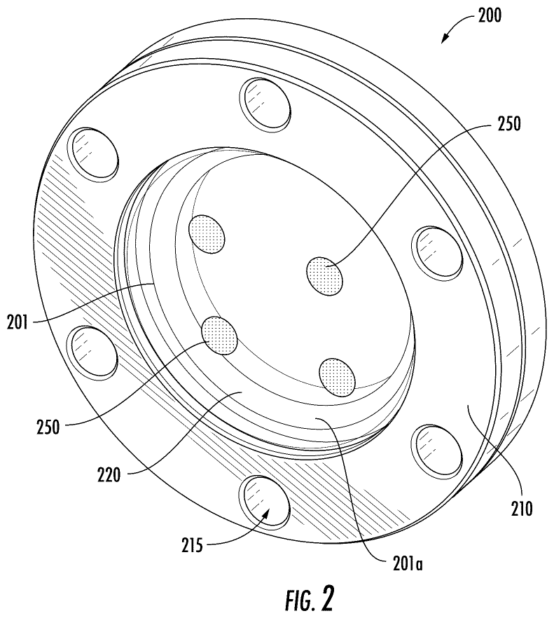

FIG. 2 provides a perspective view of an example window component 200. In various embodiments, the window component 200 comprises a window plate 220 that is secured within a collar 210. The collar 210 comprises fastening elements 215 configured for use in securing the window component 200 to the chamber housing 45 of the controlled environment chamber 40. For example, in the illustrated embodiment, the fastening elements 215 comprise holes that are configured for a bolt to pass therethrough so to bolt the window component 200 to the chamber housing 45.

In various embodiments, the window plate 220 comprises glass and/or another material that is at least partially translucent and/or transparent. For example, in an example embodiment, the window plate 220 is a glass plate or glass pane.

In various embodiments, the window plate 220 includes at least one signal manipulation element 250, such as one, two, three, four or more signal manipulation elements 250. At least one signal manipulation element 250 can be a metasurface that is integrated with a surface 201 of the window plate 220. For example, at least one signal manipulation element 250 can be a metasurface that is integrated with a first surface 201a of the window plate 220. The first surface 201a of the window plate 220 can be a surface 201 of the window plate 220 that faces toward the outside of the controlled environment chamber 40 (i.e., faces away from the inside of the controlled environment chamber 40). In various examples, at least one signal manipulation element 250 can be a metasurface that is integrated with a second surface 201b of the window plate 220 that is opposite to the first surface 201a. The second surface 201b of the window plate 220 can face toward the inside of the controlled environment chamber 40. For example, the second surface 201b of the window plate 220 is disposed within the controlled environment chamber 40.

The inside of the controlled environment chamber 40 may be a cryogenic and/or vacuum chamber configured for providing a temperature controlled and/or pressure-controlled environment within the controlled environment chamber 40. In various examples, the inside of the controlled environment chamber 40 may be configured for providing an ultra-high vacuum within the vacuum chamber such that the pressure within the vacuum chamber is less than 10⁻⁷ mbar.

In various examples, at least one signal manipulation element 250 is integrated with the core 205 of the window plate 220 (i.e., integrated with the interior of the window plate 220 such that the signal manipulation element 250 is not on a surface 201 of the window plate 220). The core 205 of the window plate may be defined between the first surface 201a and the second surface 201b of the window plate. The at least one signal manipulation element may be a diffractive optical element (DOE) and/or a photonic device that is embedded within the core 205 of the window plate 220. The at least one signal manipulation element 250 can be integrated with (e.g., embedded with) the core of the window plate 220 with a laser processing or an ion implantation technique to embed the at least one signal manipulation element 250 by locally modifying the refractive index of the material of the window plate 220.

In various examples, the window plate 220 only includes at least one signal manipulation element 250 on the first surface 201a of the window plate 220 or the second surface 201b of the window plate 220, but not both, and does not include a signal manipulation element 250 that is integrated with the core 205 of the window plate 220. In various examples, the window plate 220 includes at least one signal manipulation element 250 on the first surface 201a of the window plate 220 and on the second surface 201b of the window plate 220 but does not include a signal manipulation element 250 that is integrated with the core 205 of the window plate 220. In various examples, the window plate 220 includes at least one signal manipulation element 250 that is integrated with the core 205 of the window plate 220 but does not include a signal manipulation element 250 that is on the first surface 201a or the second surface 201b of the window plate 220. In various examples, the window plate 220 includes at least one signal manipulation element 250 that is integrated with the core 205 of the window plate 220 and at least one signal manipulation element 250 that is on the first surface 201a of the window plate 220, the second surface 201b of the window plate 220, or both.

Each signal manipulation element 250, such as each metasurface, can be configured to control at least one light characteristic of a beam of light. In various examples, each signal manipulation element 250 can be configured to control a plurality of different light characteristics of a beam of light. In various examples, each signal manipulation element 250 can manipulate a light beam and/or control at least one beam profile. For example, at least one signal manipulation element 250 may manipulate light based on scattering from nanostructures of the signal manipulation element 250. At least one signal manipulation element 250 can be a sub-wavelength patterned layer that interacts with the light to alter light properties over a subwavelength thickness. In various examples, each signal manipulation element 250 captures light and re-emits the light with a defined light characteristic. For example, at least one signal manipulation element 250 may capture light and re-emit the light with a defined amplitude, phase, polarization, modality, propagation direction, and/or spectrum. In various examples, at least one beam may be individually tailored for efficient interface coupling (i.e., mode matching) and/or for desired optical effect (e.g., Hermite-Gaussian mode generation and/or polarization control) by a signal manipulation element 250. This may be beneficial for coupling between dissimilar arrays (e.g., coupling from a PIC output that is elliptical to a fiber that is circular). In various examples, at least one signal manipulation element 250 may convert a Gaussian beam into a two lobe, a four lobe, or a flat top Gaussian beam. At least one signal manipulation element 250 may correct astigmatism or induce a stigmatism. In various examples, at least one signal manipulation element 250 is configured to rotate the polarization of a beam of light or implement polarization filtering on a beam of light.

In various examples, at least one signal manipulation element 250 may be configured to split a beam of light. For example, at least one signal manipulation element 250 may split a beam of light into two, four, eight, sixteen or more separate beams of light. In various examples, at least one signal manipulation element 250 splits a beam of light by polarization, by wavelength, by incident angle, or by intensity. The at least one signal manipulation element 250 that is configured to split a beam of light may also be configured to control at least one light characteristic of the split beam of light.

FIG. 3 provides a schematic diagram of a portion of the example system of FIG. 1 that includes a controlled environment chamber 40, in accordance with an example embodiment. As discussed, the system can include at least one external beam path system 66. When two or more external beam path systems 66 are provided, they can collectively define an array of external beam path systems 66. The system can include at least one internal beam path system 68. When two or more internal beam path systems 68 are provided, they collectively define an array of internal beam path systems 68. The system can include a window plate 220 that is positioned between the at least one external beam path system 66 and the at least one internal beam path system 68. Collectively, the at least one external beam path system 66, the at least one internal beam path system 68, and the at least one window plate 220 define a photonic interconnect system 300.

Each of the at least one external beam path systems 66 can be configured to transmit a beam of light through the window plate 220 and each of the at least one internal beam path system 68 can be configured to receive the beam of light that is transmitted through the window plate 220 by at least one of the external beam path systems 66. In various examples, each of the at least one internal beam path systems 66 can be configured to transmit a beam of light through the window plate 220 and each of the at least one external beam path system 66 can be configured to receive a beam of light that is transmitted through the window plate 220 by at least one of the internal beam path systems 66.

In various examples, at least one of the external beam path systems 66 is aligned with at least one internal beam path system 68 such that they are positioned on an imaginary line that extends through the respective external beam path system 66, the window plate 220, and the respective internal beam path system 68. In various examples, at least one of the external beam path systems 66 is not aligned with at least one internal beam path system 68.

When at least one of the external beam path systems 66 is not aligned with at least one internal beam path system 68, the signal manipulation elements 250 can be configured to bend or redirect the beam of light transmitted from the external beam path system 66 or the internal beam path system 68 to the other of the external beam path system 66 or the internal beam path system 68. This may be beneficial when re-mapping an array of beams of light transmitted from an external beam path system 66 to an internal beam path system 68. For example, a plurality of signal manipulation elements 250 may be used to transmit nine beams of light being transmitted from a 3×3 fiber bundle of the external beam path system 66 to a 1×9 PIC facet array of the internal beam path system 68.

The at least one external beam path system 66 and/or the at least one internal beam path system 68 may be mounted to the controlled environment chamber 40. For example, the at least one external beam path system 66 and/or the at least one internal beam path system 68 may be mounted to the chamber housing 45 of the environment chamber 40 or the window component 200, such as to the window plate 220 and/or to the collar 210 of the window component 200. The at least one external beam path system 66 can be coupled to the outside of the controlled environment chamber 40 and the at least one internal beam path system 68 can be mounted to the inside of the controlled environment chamber 40. For example, the at least one internal beam path system 68 can be mounted to the area within the controlled environment chamber 40 that is configured for providing a temperature controlled and/or pressure-controlled environment. The at least one external beam path system 66 and/or the at least one internal beam path system 68 may be mounted to the controlled environment chamber 40 before or after the window is installed in the controlled environment chamber 40.

The at least one external beam path system 66 and/or the at least one internal beam path system 68 may be mounted to the controlled environment chamber 40 with a reversible mounting technique. As used herein, the term “reversible mounting technique” refers to a mounting technique where a first component can be coupled to a second component and subsequently decoupled from the second component without significantly damaging the first component or the second component. As used herein, the term “non-reversible mounting technique” refers to a mounting technique where a first component can be coupled to a second component, but subsequent decoupling may cause significant damage to the first component or the second component.

In various examples, a reversible mounting technique for coupling the at least one external beam path system 66 and/or the at least one internal beam path system 68 to the controlled environment chamber 40 may include mechanically mounting the systems 66, 88 with passive alignment. For example, an engineered housing can be provided that is manufactured with a precision sufficient for efficient coupling of the system 66, 68. In various examples, the at least one external beam path system 66 and/or the at least one internal beam path system 68 can be coupled to the controlled environment chamber 40 with active alignment. For example, the systems 66, 68 can be actively aligned and subsequently clamped into place with a mechanical clamp onto the controlled environment chamber 40. In various examples, the systems 66,88 are actively aligned and then bonded in place with a reversible bonding agent, such as a reversible epoxy, solder, or other adhesive. In various examples, the systems 66, 68 are actively aligned and held in place with a vacuum force or a van der Waals force (e.g., with the use of polydimethylsiloxane (PDMS)). In various examples, the systems 66, 68 are actively aligned and held in place with a non-reversible mounting technique, such as the use of anodic bonding of glass to the glass of the window plate 220 plate or silicon to the glass of the window plate 220.

Referring still to FIG. 3, at least one of the signal manipulation elements 250 of the window plate 220 can be positioned on a different surface 201 than another one of the signal manipulation elements 250. For example, at least one of the signal manipulation elements 250a, 250b′ can be positioned on the second surface 201b of the window plate 220, which faces toward the inside of the controlled environment chamber 40. In various examples, at least one of the signal manipulation elements 250b, 250c can be positioned on the first surface 201a of the window plate 220, which faces away from the inside of the controlled environment chamber 40. In various examples, a pair of signal manipulation elements 250b, 250b′ is defined such that a signal manipulation element 250b is positioned on the first surface 201a and another signal manipulation element 250b′ is positioned on the second surface 201b, where one of the signal manipulation elements 250b of the pair is configured to direct light to the other signal manipulation element 250b′ of the pair.

In various examples, at least one of the signal manipulation elements 250 of the window plate 220 is configured to manipulate light differently than another one of the signal manipulation elements 250. For example, one of the signal manipulation elements 250 may be configured to capture light and re-emit light with a defined polarization and another one of the signal manipulation elements 250 may be configured to capture light a re-emit the light with a defined amplitude, phase, modality, propagation direction, and/or spectrum.

In various examples, at least one signal manipulation element 250 can be configured to re-map beams emitted by an array of external beam path systems 66. For example, the beams emitted by the array of external beam path systems 66 can collectively define a first shape, such as a line, a square, or a circle. The at least one signal manipulation element 250 can be configured to receive the beams emitted by the array of external beam path systems 66 and modify the propagation direction of the beams such that the beams emitted by the signal manipulation element 250 define a second shape that is different than the first shape. The beams emitted by the signal manipulation element 250 may be received by an array of internal beam path systems 68, which may collectively define a shape that corresponds to the second shape. This configuration may be beneficial when optically coupling an internal beam path system 68a to an external beam path system 66a of a different form. For example, this may be beneficial when optically coupling a 4×4 array with a 16×1 array.

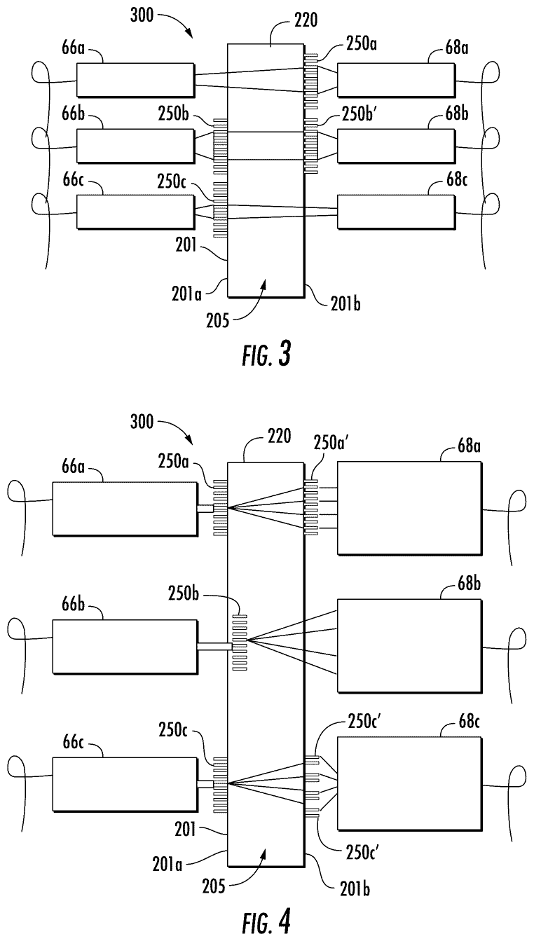

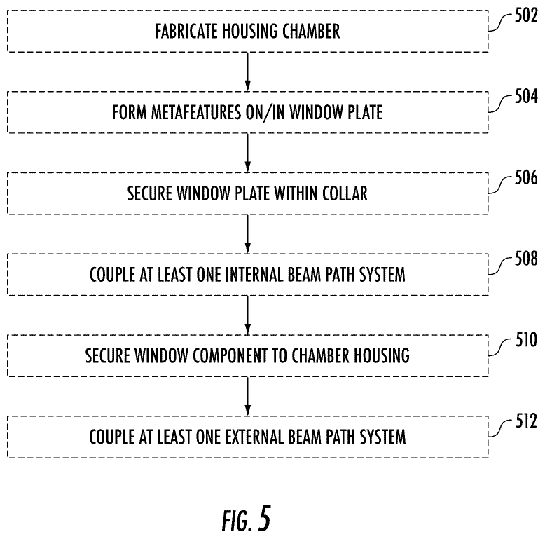

FIG. 4 provides a schematic diagram of a portion of the example system of FIG. 1 that includes a controlled environment chamber 40, in accordance with an example embodiment. As discussed, at least one signal manipulation element 250, such as signal manipulation elements 250a, 250b, and 250c may be configured to split a beam of light. The signal manipulation elements 250 that are configured to split a beam of light may be integrated with a surface 201 of the window plate 220 or may be integrated with the core 205 of the window plate 220.

In various examples, at least one other signal manipulation element 250, such as signal manipulation element 250a and signal manipulation elements 250c′, can be configured to receive at least one split beam of light and manipulate the light beam and/or control at least one beam profile. For example, at least one signal manipulation element 250 can be configured to modify a propagation direction and/or phase of the split beam of light.

### Example Method of Fabricating a Window Component and/or a Controlled Environment Chamber

FIG. 5 provides a flowchart illustrating various processes, procedures, and/or operations for fabricating a window component 200 and/or a controlled environment chamber 40 that includes a window component 200 according to various embodiments. In various embodiments, various steps may be performed simultaneously (e.g., at least partially overlapping in time) and/or in an order different from that illustrated.

Starting at step 502, a chamber housing 45 is fabricated. For example, various techniques may be used to fabricate a chamber housing 45. In various embodiments, the chamber includes an opening 42.

At step 504, at least one signal manipulation element 250 may be integrated with the window plate 220. For example, a signal manipulation element 250, such as a metasurface, can be integrated with a surface 201 of the window plate 220 by forming the signal manipulation element 250 on the surface 201 of the window plate 220. In various examples, a signal manipulation element 250 can be integrated with a core 205 of the window plate 220. The at least one signal manipulation element 250 may be integrated with the window plate 220 by forming the signal manipulation element 250 with a lithography process, such as an E-beam lithography process or a photo lithography process. In various examples, the at least one signal manipulation element 250 may be integrated with the window plate 220 by forming the signal manipulation element 250 with a pattern transfer method or a direct writing method.

In various example, at least one signal manipulation element 250 is not integrated with the window plate 220. For example, the at least one signal manipulation element 250 is integrated with a separate component (not depicted), such as a piece of glass, such as a plate of glass, a transparent film, a transparent plate, or any other component that allows light to be transmitted therethrough. The separate component with the at least one signal manipulation element 250 may be coupled to the window plate 220 and/or positioned proximate to the window plate 220. For example, the separate component may be coupled to the collar 210 or to the chamber housing 45. The separate component may be positioned between the window plate 220 and either the external beam path system 66 or the internal beam path system 68.

At step 506, the window plate 220 may be secured within a collar 210. For example, the collar 210 may be secured around a periphery of the window plate 220.

At step 508, at least one internal beam path system 68 can be coupled to the chamber housing 45 or the window component 200, such as to the window plate 220 and/or to the collar 210 of the window component 200. In various examples, the at least one internal beam path system 68 is coupled to the chamber housing 45 or the window component 200 with a reversible mounting technique. In various examples, the at least one internal beam path system 68 is coupled to the chamber housing 45 or the window component 200 with a non-reversible mounting technique.

At step 510, the window component 200 is secured to the chamber housing 45. For Example, the window component 200 may be bolted and/or otherwise fastened to the chamber housing 45 via fastening elements 215. In various embodiments, the window component 200 is secured to the chamber housing 45 so as to environmentally seal the opening 42 in the chamber housing 45.

At step 512, at least one external beam path system 66 can be coupled to the chamber housing 45 or the window component 200, such as to the window plate 220 and/or to the collar 210 of the window component 200. In various examples, the at least one external beam path system 66 is coupled to the chamber housing 45 or the window component 200 with a reversible mounting technique. In various examples, the at least one external beam path system 66 is coupled to the chamber housing 45 or the window component 200 with a non-reversible mounting technique. In various examples, at least one of the external beam path systems 68 is aligned with at least one internal beam path system 68 and at least one signal manipulation element 250 such that the external beam path system 66 is configured to transmit a beam of light through at least one signal manipulation element 250 and to the internal beam path system 68, or vice-versa.

In various examples, prior to step 508 and/or step 512, the at least one internal beam path system 68 and/or the at least one external beam path system 66 can be positioned, aligned, and/or temporarily held in place with a reversible or semi-permanent mounting technique and then coupled to the chamber housing 45 or the window component with a final technique (i.e., with a reversible or non-reversible mounting technique). For example, the at least one internal beam path system 68 and/or the at least one external beam path system 66 can be positioned or aligned and held in place with a controllable vacuum force. Subsequently, the at least one internal beam path system 68 can be coupled to the chamber housing 45 or the window component 200 (i.e., at step 508) and/or the at least one external beam path system 66 can be coupled to the chamber housing 45 or the window component 200 (i.e., at step 512).

As yet another example, an alignment tool, such as a housing, may be fabricated and used to assist with positioning, aligning, and/or holding in place the at least one external beam path system 66 and/or the at least one internal beam path system 68. The alignment tool can be designed and engineered to align all applicable components (e.g., the at least one external or internal beam path systems 66, 68) relative to the signal manipulation element 250 within optical tolerance requirements. Subsequently, the at least one internal beam path system 68 can be coupled to the chamber housing 45 or the window component 200 (i.e., at step 508) and/or the at least one external beam path system 66 can be coupled to the chamber housing 45 or the window component 200 (i.e., at step 512).

In yet another example, the alignment tool is an optical feedback device that detects and monitors alignment of the at least one external beam path system 66 and/or the at least one internal beam path system 68 relative to the signal manipulation element 250. For example, the optical feedback device may emit light through the system as intended and receive optical feedback that confirms whether the components are positioned as intended.

The alignment tool (e.g., a housing and/or an optical feedback device) may be temporary tools to assist with and ensure positioning of components when they are installed. In various examples, the alignment tool may be more permanent such that the alignment tool is used while the photonic interconnect system 300 is in use. For example, the alignment tool may be an additional beam path line that extends at least through the window plate for the purpose of ensuring positioning of components of the photonic interconnect system are maintained. The alignment tool may be designed to produce characteristic measurements in response to misalignment or be sensitive to misalignment to make those measurements easier. In use, the alignment tool may monitor, in real-time or in near real-time, intensity, polarization, and/or phase of a beam of light to ensure that the photonic interconnect system 300 continues to function as designed, and to signal if it begins to fail or is mispositioned.

Using a temporary positioning or aligning technique, or an alignment tool, may allow for more precise positioning of the internal beam path system 68 and/or the at least one external beam path system 66.

### Technical Advantages

In various scenarios, a controlled environment chamber is used to provide a controlled environment. For example, the controlled environment chamber may be a cryogenic and/or vacuum chamber configured for providing a temperature controlled and/or pressure-controlled environment within the controlled environment chamber. For example, experiments may be performed within a controlled environment (e.g., a temperature controlled, humidity controlled, pressure controlled, and/or the like) inside the controlled environment chamber. In various instances, it is desirable to pass optical signals from outside the controlled environment chamber to the inside of a controlled environment chamber, or vice versa. For example, the optical signals may include laser beams used to perform experiments on quantum objects (e.g., ions, atoms, quantum dots, and/or the like) confined within the controlled environment chamber. In another example, the optical signals may include fluorescence signals generated by quantum objects confined within the controlled environment chamber.

However, forming an opening in the housing of the controlled environment chamber to act as an optical fiber feedthrough decreases the efficiency with which the controlled environment within the controlled environment chamber may be controlled. For example, an opening in a housing of a vacuum chamber may limit the pressure to which the environment within the vacuum chamber may be reduced. Moreover, an opening in the housing of the vacuum chamber or using a different material for a feedthrough can add thermal expansion complications or reduce the mechanical stability of the housing. Therefore, technical problems exist regarding how to pass optical signals through the chamber housing of a controlled environment chamber without negatively affecting the operability of the controlled environment chamber.

Various embodiments provide technical solutions to these technical problems. For example, various embodiments provide a window component for a controlled environment chamber that includes at least one signal manipulation element integrated therewith. Optical beams may therefore be passed through the window plate via the at least one signal manipulation element. The window component seals an opening in the housing chamber of the controlled environment chamber and provides means for passing optical signals therethrough. Additionally, the window component retains the mechanical stability of the housing. Thus, various embodiments provide improvements to controlled environment chambers and systems including controlled environment chambers.

As yet another example, various embodiments provide an external beam path system that can be coupled to the chamber housing or the window component with a reversible mounting technique. This may allow the external beam path system, or components thereof, to be replaced or reconfigured without removing the window component and/or otherwise opening the controlled environment chamber, which breaks the seal (i.e., undoes the controlled environment) of the controlled environment chamber.

As yet another example, various embodiments provide at least one metasurface on the window plate that is positioned between an external beam path system and an internal beam path system, which may define a photonic interconnect system. Compared to existing technologies, the alignment sensitivity of the disclosed photonic interconnect system may be less stringent. For example, the external beam path system can have a greater misalignment with the internal beam path system without sacrificing coupling efficiency.

### Example Controller

In various embodiments, a confinement apparatus 120 disposed within a controlled environment chamber 40 is incorporated into a quantum computer 110 or other system. In various embodiments, a quantum computer 110 or other system further comprises a controller 30 configured to control various elements of the quantum computer 110 or other system. For example, the controller 30 may be configured to control the voltage sources 50; a cryogenic system, vacuum system, and/or other environmental control system controlling the environment within the controlled environment chamber 40; manipulation sources 64 (e.g., 64A, 64B, 64C); magnetic field generators; active components of external and/or internal beam path systems 66, 68; and/or the like to manipulate and/or cause a controlled evolution of quantum states of one or more quantum objects confined by the confinement apparatus 120, and/or read and/or detect a quantum state of one or more quantum objects within the confinement apparatus 120.

As shown in FIG. 6, in various embodiments, the controller 30 may comprise various controller elements including processing device 605, memory 610, driver controller elements 615, a communication interface 620, analog-digital converter elements 625, and/or the like. For example, the processing device 605 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 605 of the controller 30 comprises a clock and/or is in communication with a clock.

For example, the memory 610 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 610 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 610 (e.g., by a processing device 605) causes the controller 30 to perform one or more steps, operations, processes, procedures and/or the like described herein for controlling one or more components of the quantum computer 110 or other system, e.g., voltages sources 50, manipulation sources 64, magnetic field generators, and/or the like) to cause a controlled evolution of quantum states of one or more quantum objects, detect and/or read the quantum state of one or more quantum objects, and/or the like.

In various embodiments, the driver controller elements 615 may include one or more drivers and/or controller elements each configured to control one or more drivers. In various embodiments, the driver controller elements 615 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 605). In various embodiments, the driver controller elements 615 may enable the controller 30 to operate a manipulation source 64. In various embodiments, the drivers may be laser drivers; vacuum component drivers; drivers for controlling the flow of current and/or voltage applied to longitudinal, RF, and/or other electrodes used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the potential generating elements of the confinement apparatus 120 (e.g., control electrodes and/or RF electrodes). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like). For example, the controller 30 may comprise one or more analog-digital converter elements 625 configured to receive signals from one or more detectors, optical receiver components, calibration sensors, photodetectors of an optics collection system, and/or the like.

In various embodiments, the controller 30 may comprise a communication interface 620 for interfacing and/or communicating with a computing entity 10. For example, the controller 30 may comprise a communication interface 620 for receiving executable instructions, command sets, and/or the like from the computing entity 10 and providing output received from the quantum computer 110 (e.g., from an optical collection system comprising one or more photodetectors) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

FIG. 7 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 7, a computing entity 10 can include an antenna 712, a transmitter 704 (e.g., radio), a receiver 706 (e.g., radio), and a processing device 708 that provides signals to and receives signals from the transmitter 704 and receiver 706, respectively. The signals provided to and received from the transmitter 704 and the receiver 706, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 comprises a network interface 720 configured to communicate via one or more wired and/or wireless networks 20.

In various embodiments, the processing device 708 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products.

The computing entity 10 may also comprise a user interface device comprising one or more user input/output interfaces (e.g., a display 716 and/or speaker/speaker driver coupled to a processing device 708 and a touch screen, keyboard, mouse, and/or microphone coupled to a processing device 708). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 718 (hard or soft), a touch display, voice/speech or motion interfaces, scanners, readers, or other input device. In embodiments including a keypad 718, the keypad 718 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 722 and/or non-volatile storage or memory 724, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the appended claims below. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A controlled environment chamber comprising:
a chamber housing; and
a window component secured to the chamber housing, wherein the window component comprises:
a window plate having a first surface that faces away from an interior of the controlled environment chamber and a second surface that faces toward the interior of the controlled environment chamber, wherein the window plate comprises at least one signal manipulation element.

2. The controlled environment chamber of claim 1, wherein the window plate has a core that is defined between the first surface and the second surface, wherein the at least one signal manipulation element is embedded within the core of the window plate.

3. The controlled environment chamber of claim 1, wherein an inside of the controlled environment chamber is configured for providing an ultra-high vacuum that is less than 10⁻⁷ mbar.

4. The controlled environment chamber of claim 1, wherein a first signal manipulation element of the at least one signal manipulation element is positioned on the first surface of the window plate.

5. The controlled environment chamber of claim 4, wherein a second signal manipulation element of the at least one signal manipulation element is positioned on the second surface of the window plate.

6. The controlled environment chamber of claim 1, wherein each of the at least one signal manipulation element is configured to control at least one light characteristic of a beam of light passing through the respective signal manipulation element.

7. The controlled environment chamber of claim 6, wherein the at least one light characteristic is an amplitude, a phase, a polarization, a modality, a propagation direction, a spectrum of light, or a combination thereof.

8. The controlled environment chamber of claim 1, wherein each of the at least one signal manipulation element is configured to split a beam of light passing through the respective signal manipulation element.

9. The controlled environment chamber of claim 1, further comprising a photonic interconnect system, the photonic interconnect system comprising:
at least one external beam path system;
the window plate comprising the at least one signal manipulation element; and
at least one internal beam path system,
wherein each of the at least one signal manipulation element of the window plate is positioned between a corresponding external beam path system and a corresponding internal beam path system.

10. The controlled environment chamber of claim 9, wherein the at least one internal beam path system is optically coupled to a confinement apparatus.

11. The controlled environment chamber of claim 10, wherein the confinement apparatus is an ion trap that is configured to confine at least one quantum object.

12. The controlled environment chamber of claim 9, wherein the at least one external beam path system or the at least one internal beam path system is configured to transmit a beam of light through a respective signal manipulation element and the other of the at least one external beam path system or the at least one internal beam path system is configured to receive the beam of light that is transmitted through the respective signal manipulation element.

13. The controlled environment chamber of claim 9, wherein the photonic interconnect system comprises:
an array of external beam path systems that collectively define a first shape; and
an array of internal beam path systems that collectively define a second shape,
wherein the second shape is different than the first shape.

14. The controlled environment chamber of claim 13, wherein the at least one signal manipulation element is configured to receive a plurality of beams of light from the array of external beam path systems, modify the propagation direction of at least one of the plurality of beams of lights such that the plurality of beams of light that are emitted by the signal manipulation element define the second shape.

15. The controlled environment chamber of claim 9, wherein the at least one external beam path system and/or the at least one internal beam path system is coupled to the chamber housing or the window component with a reversible mounting technique.

16. A method of fabricating a controlled environment chamber, the method comprising:
integrating at least one signal manipulation element with a window plate;
coupling at least one internal beam path system to a chamber housing of the controlled environment chamber or to a window component that comprises the window plate;
securing the window component to the chamber housing; and
coupling at least one external beam path system to the chamber housing or to the window component.

17. The method of claim 16, further comprising aligning the at least one external beam path system with the at least one signal manipulation element and the at least one internal beam path system.

18. The method of claim 16, further comprising using an alignment tool to (1) assist with positioning the at least one internal beam path system or the at least one external beam path system and/or (2) assist with monitoring the position of the at least one internal beam path system or the at least one external beam path system.

19. The method of claim 18, wherein coupling the at least one external beam path system to the chamber housing or to the window component comprises coupling the at least one external beam path system to the chamber housing or to the window component with a reversible mounting technique.

20. The method of claim 16, further comprising securing the window plate within a collar, wherein the collar is configured to couple the window component to the chamber housing of the controlled environment chamber.
